(19) United States
(12) Patent Application Publication
(10) Pub. No.: US 2010/0304085 A1
(43) Pub. Date: Dec. 2, 2010

(54) Method for producing a non-woven/sheet laminate

(76) Inventor: Alexandra Steger, Heidenheim (DE)

Correspondence Address: DREISS, FUHLENDORF, STEIMLE & BECKER, POSTFACH 10 37 62, D-70032 STUTTGART, DE

(21) Appl. No.: 12/854,189

(22) Filed: Aug. 11, 2010

Related U.S. Application Data
(63) Continuation of application No. 11/579,392, filed on Nov. 2, 2006.

(30) Foreign Application Priority Data
May 7, 2004 (DE) 10 2004 024 042.6

(51) Int. Cl. B32B 3/10; B32B 37/14

(52) U.S. Cl. 428/141; 156/299

(57) ABSTRACT

A method for manufacturing a non-woven/sheet laminate, involves preparing a sheet having a first and a second side, the sheet being made from a film or foil which is not a non-woven material. A first non-woven layer is disposed on the first side of the sheet and a second non-woven layer is disposed on the second side of the sheet, a visible side of the second non-woven layer having a linting coefficient of less than 2.7 and a sliding coefficient of friction of between 0.35 and 0.75. At least one of the first and the second non-woven layers comprises spunbond and meltblown layers with an outwardly facing spunbond layer. The non-woven/sheet laminate is subjected to a thermal treatment process and associated reduction in length in a flat direction.

This application is a continuation of 11/579,392 filed Nov. 2, 2006 as the national stage of PCT/EP2005/004132 filed on Apr. 19, 2005 and also claims Paris Convention priority of DE 10 2004 024 042.6 filed on May 07, 2004 the entire disclosures of which are hereby incorporated by reference.

### BACKGROUND OF THE INVENTION

The invention concerns a method for manufacturing a non-woven/sheet laminate comprising a sheet and a non-woven layer on both sides of the sheet.

Non-woven/sheet laminates are well known in the art. WO 99/14262 describes e.g. a non-woven/sheet laminate comprising a polyethylene film which contains a filler to render the sheet microporous, wherein the film and a non-woven material are laminated together. A non-woven material may thereby be disposed on one or both sides of the film.

In addition to providing a sheet with mechanical stability, non-woven materials also advantageously have tactile properties which, when used for clothes, are more pleasant to wear than are foil materials. Such laminates are therefore used e.g. as material for surgical wear, and also in the biotechnological and chemical fields.

Despite their more pleasant tactile properties compared to foils, non-woven materials bear an increased safety risk during use compared to films or foils. Non-woven materials are disadvantageous, since the fiber cohesion is insufficient for many applications. Non-woven materials moreover have a smooth surface. Such smooth surfaces are disadvantageous in that the desired haptic properties of a textile material cannot be reliably obtained.

A plurality of documents disclose laminates with which a non-woven material is disposed on one side of a film, e.g. WO 00/20208 which discloses a corresponding laminate for use as a surgical material.

WO 03/086758 moreover discloses a “low-linting” laminate which consists of a net-like sheet and an absorbing sheet which is connected to one side thereof. This laminate may be used as a cover for operations or in hygiene products.

Further non-woven/sheet laminate materials are disclosed e.g. in EP 0 912 788 B1 which discloses a film/non-woven laminate with a drawn film which is reinforced by an adhesive.

It is the underlying purpose of the present invention to provide a method for producing a non-woven/sheet laminate which is suited, in particular, as a material for use in surgery, comprising a sheet and a non-woven layer on both sides of the sheet, wherein the tactile properties of the non-woven material preferentially correspond to those of a textile material, thereby also obtaining the required criteria for use of such materials such as e.g. water vapor permeability, water impermeability, and mechanical stability. Moreover, a material shall be created which ensures safe working conditions when used in a work environment.

### SUMMARY OF THE INVENTION

This object is solved by the invention with a method for manufacturing a non-woven/sheet laminate, the method comprising the steps of:
a) preparing a sheet having a first and a second side, said sheet being made from a film or foil which is not a non-woven material;
b) disposing a first non-woven layer on said first side of said sheet; and
c) disposing a second non-woven layer on said second side of said sheet, wherein a visible side of said second non-woven layer has a linting coefficient of less than 2.7 and a sliding coefficient of friction of between 0.35 and 0.75, at least one of said first and said second non-woven layers comprising spunbond and meltblown layers with an outwardly facing spunbond layer; and
d) subjecting, following steps a) through c), the non-woven/sheet laminate to a thermal treatment process and associated reduction in length in a flat direction.

The linting coefficient may, in particular, be less than 2.5 and, in particular, less than 2.2. With such a linting coefficient, the surface is sufficiently rough to produce a haptic textile impression of the non-woven/sheet laminate.

Linting is the tendency of a textile or non-woven to release material fragments during use. Linting in connection with a non-woven material means the release of particles such as fiber fragments or other components which are used to produce a non-woven material, during use.

This release of particles is important, since a minimum amount of particles should be released from materials which are used in the surgical field for reasons of sterility and soiling. The release of particles is also undesirable in other fields of application which require particularly clean working conditions. A linting coefficient of less than 2.7, in particular less than 2.5, in particular less than 2.2, thereby corresponds to a number of particles (particles larger than 3 μm) per sample, as is specified in more detail in the test described below, of less than 500 particles, in particular less than 320 particles and, in particular less than 160 particles.

### DESCRIPTION OF THE PREFERRED EMBODIMENT

In accordance with a particularly preferred embodiment, the at least one surface forming a visible side of the laminate should additionally have a sliding friction coefficient μ of between p=0.35 and 0.75. The sliding friction coefficient may, in particular, be between p=0.40 and 0.70 and, in particular, between 0.45 and 0.65. Such a sliding friction coefficient yields a sufficiently rough surface to produce the haptic textile impression of the non-woven/sheet laminate. The sliding friction coefficient in a planar direction of the laminate is preferably the same in both directions (machine direction and transverse direction during laminate production). The laminate may then be further processed without limitations.

Friction is the sliding resistance between two surfaces lying on top of each other. One distinguishes between static and sliding friction. The static friction is the friction which is present as a threshold value at the start of a sliding motion between bodies which are at rest relative to each other, wherein the acting force is insufficient to produce relative motion.

In contrast thereto, sliding friction is the friction which remains effective at a predetermined sliding speed directly after the static friction between the bodies being moved relative to each other has been overcome. The sliding friction force F_{D} is thereby the force required to overcome sliding friction. The sliding friction coefficient μ is determined by the ratio between the sliding friction force and the normal force F_{N} by μ=F_{D}/F_{N}.

Increased roughness is advantageous for the goods produced from the material, such as surgical coats and covering sheets for the surgical field. When the material is excessively smooth, the sheet could slip off, thereby impairing the work safety. The inventively manufactured material therefore also has anti-slip properties.

In particular, no additional mechanical or chemical treatment of the surface is provided or required in accordance with the invention in order to increase the roughness. In particular, no additional coating, impregnation or introduction of further means to increase the surface roughness are either provided or necessary.

Despite the increased roughness, which is always accompanied by an increased particle release in prior art since the surface is conventionally mechanically roughened, a minimum amount of particles is released, thereby permitting use in working environments which require the highest purity.

The laminate is thereby not additionally surface-treated or rendered hydrophobic. It is rather an independently hydrophobic laminate, wherein, in particular, the non-woven layers are hydrophobic. As defined herein, the terms mufti-layer and mufti-ply as well as layer and ply are used interchangeably.

The non-woven layer may thereby be designed to have several layers on one or both sides of the sheet. In particular, spunbond and nneltblown layers may be provided which are alternately disposed, in particular, as spunbond/meltblown/spunbond layers or also as spunbond/meltblown/meltblown/spunbond layers. The layer facing outwardly is thereby preferably a spunbond layer. This produces favorable characteristics of the non-woven layer, in particular, since the sheet and also the nneltblown layers retain a certain amount of liquid.

The non-woven material may preferably be thermally solidified, e.g. using a diamond calender. The non-woven/sheet laminate may thereby be produced in one single method step, or alternatively, the non-woven layers may be initially separately produced and subsequently connected to the sheet.

The sheet may, in particular, be a water-impermeable but water vapor permeable sheet. The laminate consequently has a water vapor permeability (WVTR) of, in particular, more than 4000 g/m²/24 h. The laminate has moreover a water resistance which is defined by a water column of, in particular, more than 400 cm and, in particular, more than 500 cm.

The sheet may, in particular, be microporous. This microporosity may, in particular, be introduced into a sheet by providing it with a non-polymeric, particulate filler, in particular, calcium carbonate, and subsequent drawing of the produced sheet such that capillaries form at the phase borders between the plastic material and the filler, which remain even after releasing the sheet.

The sheet may comprise polyolefines, preferably polyethylenes. The sheet may, in particular, consist of a thermoplastic polymer blend comprising two or more different polyethylenes. The polymer blend may, in particular, comprise LDPE and LLDPE.

In accordance with the invention, the non-woven/sheet laminate is produced using a heat treatment process accompanied by a reduction in length in the flat direction. The length in the flat direction may thereby be reduced preferably in only one flat direction (preferred direction), wherein reduction in length in only one direction means that the reduction in length perpendicularly to the preferred direction is at most 1/10 of the reduction in length of the preferred direction. The length reduction in at least one direction may thereby be at least 2% and in particular at least 3% of the length of the sample in this direction. The reduction in length in at least one direction may thereby be at most 10% and in particular at most 6% of the length of the sample in this direction. The temperatures thereby used may be between 45 and 100° C. and, in particular, between 45 and 90° C. and, in particular, between 45 and 80° C. and moreover, in particular, between 50 and 65° C. during thermal treatment. Shrinking or length reduction in the flat direction is thereby effected, in particular, in the direction corresponding to the machine direction (MD) during production of the non-woven/sheet laminate. With particular preference, the length reduction is combined with a sterilization step for the material or, in particular, the finished product, such that no additional step is required. The length reduction in one direction moreover increases the laminate thickness, wherein the laminate or, in particular, the non-woven material is warped. The fibers of the non-woven material thereby bulge without impairing the fiber cohesion. This is evidenced by the very small linting coefficient.

The reduction in length may thereby increase the thickness by more than 30%, in particular, more than 40% and, in particular, more than 50%. The inventive laminates may thereby preferably have a thickness before thermal treatment of 0.2 to 1.0 mm, in particular, 0.3 to 0.8 mm, and preferentially 0.4 to 0.6 mm. The inventively produced laminates may also preferably have a thickness following thermal treatment of 0.3 to 1.5 mm, in particular 0.4 to 1.0 mm and preferentially 0.5 to 0.7 mm. The layers, i.e. the sheet with the non-woven layers may be connected by an adhesive which is disposed, in particular, not over the full surface, and is, in particular, a fusion adhesive. A method for non-full surface application is e.g. a contact method in accordance with EP 568 812 A1. Alternatively, the layers may be connected through thermal solidification methods or by ultrasound.

In a particularly preferred embodiment, the non-woven/sheet laminate is symmetrical relative to the sheet. The layer structure i.e. the number and sequence of the spunbond and meltblown layers may be symmetrical as well as the materials used for producing the individual spunbond or meltblown layers. Symmetry may also be considered with regard to the differing characteristics of the sides of the non-woven layers associated with the production process.

The invention also concerns production of a disposable piece of clothing which can, in particular, be sterilized, wherein, in particular, the surface-forming walls of the piece of clothing may be formed from a corresponding non-woven/sheet laminate. The material may also be used for covers, in particular in the surgical field and for surgical clothes, such as surgical jackets and coats as well as caps etc.

In accordance with the invention, a non-woven/sheet laminate is produced with a layer composite of sheet and the non-woven layers connected to both sides of the sheet In consequence of the thermal treatment, the length of the layer composite is reduced in the flat direction. The thermal treatment may be performed, in particular, at temperatures of between 45 and 100° C. and, in particular, between 45 and 90° C. and, in particular, between 45 and 80° C. and moreover, in particular, between 50 and 65° C. The length may be reduced, in particular, in only one direction in the plane, wherein reduction in length in only one direction means that the length reduction perpendicular to the preferred direction is at most 1/10 of the length reduction of the preferred direction. The length reduction in at least one direction may thereby be at least 2% and, in particular, at least 3% of the length of the sample in this direction. The length reduction in at least one direction may thereby be at most 10% and, in particular, at most 6% of the length of the sample in this direction.

The test methods used are explained in more detail below:

Linting coefficient:

The linting coefficient is determined in accordance with the international standard ISO 9073-10. Measurement was performed with a device Gelbo Flex 5000 of the company Instrument Marketing Services/Fairfield and a Counter LS 31C of the company SFP.

Sliding friction coefficient:

The friction ratio was measured in accordance with DIN 53375, wherein the following test devices were used:
hydraulic punch
punching tool 65×200 mm ±0.25 mm
punching tool 150×300 mm ±0.25 mm
tension testing machine according to DIN 51221 class 1
additional device consisting of sample table with removal carriage
friction block according to DIN 53375 (produced by F. A. Zwick/Roell).

Sample preparation: The samples must be stored in a standard atmosphere DIN 50014—23/50-2—for at least 16 hours. The samples may not be bent, folded or scratched. Finger prints, dust and other soiling must be prevented.

Testing is performed with the laminate outer sides opposite each other, i.e. the same sides are tested with respect to each other, wherein the machine direction and the transverse direction of the laminate are taken into consideration in the measurement, and corresponding directions of the laminate are measured with respect to each other.

Test method: the test body 1 (150×300 mm) is mounted to the base plate of the sample table with maximum alignment. The test body 2 (65×200 mm) is clamped into the friction block without creasing, and fastened on the force transducer using a thread (without twisting). The friction block, including test body 2, is carefully disposed onto the test body 1, such that the test sides contact each other. The connection to the force transducer should thereby not yet be tensioned. The test is started 15 seconds after disposing the friction block. The test may be terminated after a friction path of approximately 60 mm. The test speed is 100 m per minute, for both the pre- and post-measurement paths.

Analysis: the pre-measurement path of 10 mm and the post-measurement path of 10 mm are not used in the analysis. The force dependence of a longer sliding motion often deviates from the ideal of a constant level due to secondary effects. Only the force dependence of the path of 60 mm is used to determined the sliding friction value μ.

The sliding friction value μ is obtained in accordance with the following formula: μ: μ=F_{D}:F_{N}, wherein F_{D} is the sliding friction force in Newtons and F_{N} is the normal force in Newtons (here in accordance with the standard: F_{N}=1.96 N). A sample number of at least n=5 should thereby be used, and the average value and the standard deviation are rounded to two digits after the decimal point to thereby determine the sliding friction of the non-woven/sheet laminate.

Water vapor volume resistance:

The water vapor volume resistance Rₑₜ=(m² Pa/W) was measured as follows:
test device: thermo regulation model of the human skin (skin model, research institute Hohenstein, Castle Hohenstein, 74357 Bönningheim, Germany)
test conditions: DIN 31092 (02/94) or ISO 11092 (10/93)
test climate: temperature 35° C., 40% relative moisture

An average was formed from three individual measurements on three different sample sections.

Clothes are thereby considered to be more physiologically favorable, the lower the material-specific water vapor volume resistance Rₑₜ, since this leads to improved evaporation of perspiration from the user's body. The following criteria, obtained from research, can be used to assess the physiological quality of textiles with barrier effect, in particular, for surgical clothes: Rₑₜ≦8 m² Pa/W=very good, Rₑₜ>40 m²Pa/w=insufficient.

Measurement of thickness:

The method determines the thickness of flat structures under a defined load using a mechanical thickness measuring device having a measuring scale, different weights, a measuring surface of 25 cm², and a scale setting of 0.01 mm. A test sample of a sufficiently large size is cut out from the test material and the test sample is prepared at the standard climate (23° C., 50% moisture). The thickness measuring device is operated in accordance with the operating instructions and the thickness is measured as specified at a load of 5 g/cm² in millimeters to exactly 0.01 mm. In the evaluation, the thickness of five samples is measured in millimeters, therefrom determining the average value, which is rounded to two decimal places.

The inventive dimensional information thereby corresponds to the average value determined in accordance with the stated test method, unless otherwise specified.

The invention is also explained in more detail below by means of an example.

Further advantages and features of the invention can be extracted from the following example and its description: The example concerns a non-woven/sheet laminate which is formed by stacking two layers of non-woven and one microporous sheet symmetrically with respect to the central sheet layer. Each non-woven layer thereby consists of a spunbond/meltblown/meltblown/spunbond laminate (SMMS) which is thermally solidified and also symmetrically structured. The two central layers of the meltblown material cannot be separately identified after production. The non-woven layer and the sheet are connected using a hot fusion adhesive with a surface application of 2 g/m² of connecting surface. It is applied onto a portion of the surface using the contact coating method in accordance with EP 568 812 A1 and via controllable slot dies. The non-woven material thereby has the following properties:
surface density 17 g/m²
distribution SMMS=6.8−1.7−1.7−6.8 [g/m²]

The non-woven material consists of different polypropylenes (PP). None of the layers is subjected to an anti-static surface treatment or is subsequently rendered hydrophobic.

The sheet consists of a thermoplastic polymer blend of low density polyethylene (LDPE) and a linear-low density polyethylene (LLDPE) and a filler, in the present case calcium carbonate (CaCO₃).

The sheet has one layer, is not elastic, has a surface density of 25 g/m², and a film thickness of 25 μm. The sheet contains 50 weight % (±12 weight %) of calcium carbonate having an average particle diameter of less than 2 μm. It is uniaxially drawn in the machine direction in order to provide micropores in the sheet.

The laminate was then subjected to tests in accordance with the above-described methods, i.a. to determine the parameters and the shrinking behavior. Thermal treatment was performed in a warming cabinet at 54° C. and 70% relative air moisture for 6 hours. The following values were determined:

1. length change (laminate) due to thermal treatment

The measurements were performed on 5 punched-out material pieces of identical sizes of 206 mm×294 mm (MD×CD). All five samples had a size of 200 mm×296 mm (MD×CD) after thermal treatment and in the cooled state at room temperature.

Length change in the machine direction (MD): −2.9%

Length change in the transverse direction (CD): +0.7%

2) surface density (F)/g/m²—averaged over 10 measurements (average value and standard deviation) measured with Mettler Toledo PB 3002

F (before thermal treatment)=63.2 g/m² (s=1.7 g/m²)

F (after thermal treatment)=65.6 g/m² (s=1.0 g/m²)

The surface density thereby increases on average by approximately 4% due to thermal treatment.

3) Measurement of thickness, thickness (D)/mm—averaged over 10 measurements (average value and standard deviation)

D (before thermal treatment)=0.43 mm (s=0.005 mm)

D (after thermal treatment)=0.66 mm (s=0.020 mm)

The thickness thereby increases on average by approximately 53% due to thermal treatment.

4) sliding friction coefficient μ—averaged over 10 measurements (average value and standard deviation)

μ (MD, before thermal treatment)=0.46 (s=0.04)

μ (MD, after thermal treatment)=0.52 (s=0.07)

μ (CD, before thermal treatment)=0.48 (s=0.04)

μ (CD, after thermal treatment)=0.57 (s=0.06)

This is followed by a test after sterilization with ethylene oxide and heat under the same conditions as before (54° C., 70% relative air humidity, duration 6 h):

1) length change (laminate):

The measurements were performed on 5 punched-out material pieces of identical sizes of 206 mm×294 mm (MD×CD). All five samples had a size of 200 mm×296 mm (MD×CD) after thermal treatment and in the cooled state at room temperature.

Length change in the machine direction (MD): −3.0%

Length change in the transverse direction (CD): 0.0%

2) surface density (F)/g/m²—averaged over 10 measurements (average value and standard deviation) measured with Mettler Toledo PB 3002

F (before thermal treatment)=65.2±1.3 g/m²

F (after thermal treatment)=66.6±1.0 g/m²

The surface density thereby increases on average by approximately 2% due to thermal treatment.

3) Measurement of thickness, thickness (D)/mm—averaged over 5 measurements (average value and standard deviation)

D (before thermal treatment)=0.43 ±0.005 mm

D (after thermal treatment)=0.68 ±0.005 mm

The thickness thereby increases on average by approximately 58% due to thermal treatment.

4) sliding friction coefficient μ—averaged over 5 measurements (average value and standard deviation)

μ (MD, before thermal treatment)=0.46±0.02

μ (MD, after thermal treatment)=0.51±0.02

μ (CD, before thermal treatment)=0.51±0.03

μ (CD, after thermal treatment)=0.52±0.03

5) water vapor permeability (WVTR)/g/m²/24 h (climate B)—averaged over 5 measurements (average value and standard deviation), according to DIN 53 122-1

WVTR (before thermal treatment)=5182±115 g/m²-24 h

WVTR (after thermal treatment)=5149±252 g/m²-24 h

6) water column (W)/cm for a gradient of 60 mbar/min—averaged over 5 measurements (average value and standard deviation) according to EN 20 811 device Textest FX 3000

W (before thermal treatment)=565±45 cm

W (after thermal treatment)=592±20 cm

7) water vapor volume resistance—averaged over 3 measurements Rₑₜ=25.07 m² Pa/W

Linting values were moreover determined in 5 samples, wherein both sides were measured in each case. The results were between 1.28 and 2.49 which corresponds to an amount of particles of more than 3 μm per sample of between 19 and 310.

8) linting (L)/number of particles>3 μm

Gelbo Flex 5000 ES by Instrument Marketing Services of Fairfield; Counter LS 31C of the company SFP

A sterile material, which was sterilized in accordance with the above-mentioned conditions, was tested—5 measurements per side (average value and standard deviation)

L (side 1)=130±116

L (side 2)=105±113

The invention thereby provides a material which can be used with particular advantage for surgical applications, such as e.g. surgical aprons and coats, surgical caps and cover sheets due to its pleasant textile properties and at the same time low linting coefficient. Moreover, the material can be easily produced and further processed.

I claim:

1. A method for manufacturing a non-woven/sheet laminate, the method comprising the steps of:
a) preparing a sheet having a first and a second side, said sheet being made from a film or foil which is not a non-woven material;
b) disposing a first non-woven layer on said first side of said sheet; and
c) disposing a second non-woven layer on said second side of said sheet, wherein a visible side of said second non-woven layer has a linting coefficient of less than 2.7 and a sliding coefficient of friction of between 0.35 and 0.75, at least one of said first and said second non-woven layers comprising spunbond and meltblown layers with an outwardly facing spunbond layer; and
d) subjecting, following steps a) through c), the non-woven/sheet laminate to a thermal treatment process and associated reduction in length in a flat direction.

2. The method of claim 1, wherein said linting coefficient is less than 2.5.

3. The method of claim 2, wherein said linting coefficient is less than 2.2.

4. The method of claim 1, wherein said sliding coefficient of friction is between 0.40 and 0.70 or between 0.45 and 0.65.

5. The method of claim 1, wherein at least one of said first and said second non-woven layers is a spunbond/meltblown/spunbond laminate.

6. The method of claim 1, wherein at least one of said first and said second non-woven layers is a spunbond/meltblown/meltblown/spunbond laminate.

7. The method of claim 1, further comprising thermally solidifying at least one of said first and said second non-woven layers.

8. The method of claim 1, wherein at least one of said first and said second non-woven layers is hydrophobic.

9. The method of claim 1, wherein the laminate withstands a water column of W>400 cm or of W>500 cm.

10. The method of claim 1, wherein the laminate has a water vapor permeability of WVTR>4000 g/m²/24 h.

11. The method of claim 1, wherein said sheet is microporous.

12. The method of claim 1, wherein said sheet comprises polyolefines or polyethylenes.

13. The method of claim 1, wherein said sheet comprises a non-polymeric, particulate filler or CaCO₃.

14. The method of claim 1, wherein said length is reduced in substantially one direction only.

15. The method of claim 1, wherein said first and said second the non-woven layers are connected to said sheet by an adhesive.

16. The method of claim 15, wherein said adhesive is not disposed on an entire surface.

17. The method of claim 15, wherein said adhesive is a hot fusion adhesive.

18. The method of claim 15, wherein the non-woven/sheet laminate is structured or symmetric relative to said sheet.

19. The method of claim 1, further comprising fashioning the non-woven/sheet laminate into a disposable piece of clothing or into a disposable piece of clothing which can be sterilized.

20. The method of claim 1, wherein the thermal treatment of step d) is performed at a temperature between 45 and 100° C., between 45° and 90° C., between 45° and 80° C., or between 50° and 65° C.

21. The method of claim 1, wherein step d) simultaneously effects sterilization.

22. The method of claim 1, wherein said reduction in length is between 2 and 6%.

23. A non-woven/sheet laminate produced by the method of claim 1.
